(19) United States
(12) Patent Application Publication
(10) Pub. No.: US 2011/0025123 A1
(43) Pub. Date: Feb. 3, 2011

(54) DYNAMO AND POWER SUPPLY MANAGEMENT DEVICE FOR BICYCLES

(76) Inventor: Chin-Sung Tsai, Hsin Chuang (TW)

Correspondence Address: The Weintraub Group, P.L.C., 28580 Orchard Lake Road, Suite 140, Farmington Hills, MI, 48334, US

(21) Appl. No.: 12/821,211

(22) Filed: Jun. 23, 2010

(30) Foreign Application Priority Data
Jul. 30, 2009 (TW) 098213959

(51) Int. Cl. B60L 1/00; H02P 9/48; H02J 7/14

(52) U.S. Cl. 307/9.1; 322/28; 307/66

(57) ABSTRACT

A dynamo and power supply management device for bicycles includes a rectification and filter circuit connected with a dynamo, an electronic switch set connected between the rectification and filter circuit and a load, a control unit controlling the electronic switch set between on and off, a voltage measurement unit connected with an output terminal of the rectification and filter circuit, and an energy storage module connected to the dynamo and the load through the electronic switch set. The energy storage module is composed of multiple energy storage units. The control unit determines the energy storage unit to be charged based on a built in charge and discharge parameter table and the power generated by the dynamo and selects an energy storage unit to supply power to the load, thereby fully utilizing the power generated by a bicycle and enhancing the operation efficiency.

### BACKGROUND OF THE INVENTION

1. Field of the Invention

The present invention is related to a dynamo and power supply management device, and more particularly to a device targeting at the management of dynamo and power supply for bicycles.

2. Description of the Related Art

Bicycles are currently a very popular sports tool by which people spend their leisure time and are also a transportation tool in compliance with the concepts of environmental protection. Being either for spending leisure time over weekend or holiday or for serving as a transportation tool, the demand of bicycles has skyrocketed recently. Furthermore, people also use bicycles as a tool for long journeys. All these demands open the door to more and more accessories of bicycle. For example, cell phones, lighting, notebook computers, personal data assistants, digital players (MP3 or MP4), GPS and the like are all possible items carried during a bicycle tour. However, most of these accessories pertain to electronic products, meaning that they rely on either normal battery cell or a rechargeable battery to operate and the rechargeable battery would be preferred. After being operated for a while, these electronic products have to be charged before power is used up. However, finding a power outlet in a bicycle tour could be as difficult as finding water in a desert sometimes.

In fact, finding power sources is not just a miracle in a bicycle tour. The easiest and accessible power source turns out to be a dynamo system of a bicycle. Regular dynamo systems for a bicycle supplies power for lighting. Unless riding at night for long hours, most of the power generated by the dynamo system is available. Therefore, the dynamo system in a bicycle has sufficient power to supply equipment other than just bicycle lamps. The foregoing description simply explores a feasibility study instead of a concrete implementation technique requiring more development ahead. Given the example of the dynamo system, power generated by the system must be managed more efficiently and the selection of power storage media shall also meet the characteristics and requirements of various electronic products.

So far, the existing power storage media include rechargeable battery, capacitor, ultra capacitor (or super capacitor) and so forth. Rechargeable battery usually has more storage capacity, but it requires special design of charging circuit and discharging control circuit so as to prevent the damage to the battery as a result of over-charge and over-discharge. Ultra capacitor stores energy from the separated charges. The larger the area storing charges, the more concentrated the separated charges, or the more capacitance. The area of an ultra capacitor depends on porous carbon materials. The porous structure of the materials provides more area so that ultra capacitor possesses a large capacitance with a great disparity in contrast to conventional capacitor. Besides, ultra capacitor has the following advantages:
1. tiny size but providing a farad-grade capacitance;
2. no special design of charging circuit and discharging control circuit; if compared with rechargeable battery, the life duration of ultra capacitor is not affected by over-charge and over-discharge;
3. a green power in compliance with the concepts of environmental protection.

Despite all the above-mentioned advantages of ultra capacitor, it does not mean that ultra capacitor can completely replace rechargeable battery in terms of dynamo and power supply of bicycle. Ultra capacitor is advantageous in ideal power characteristic, but power storage thereof is still far behind that of rechargeable battery.

Therefore, conventional electric power storage media are good in their respective fields as far as their characteristics are concerned. The principle in adopting those media lies in not simply replacing but efficiently and selectively choosing the power storage media in consideration of the characteristics of various power-requiring equipment.

### SUMMARY OF THE INVENTION

The main objective of the present invention is to provide a dynamo and power supply management device for bicycles. The device incorporates various energy storage units with different characteristics and selectively charges different energy storage units and selectively supplies power to different load with an appropriate energy storage unit in accordance with the power generation status and the actual power-consuming demand, thereby significantly enhancing the operation efficiency of the dynamo for bicycles.

To achieve the foregoing main objective, the dynamo and power supply management device for bicycles has a power input terminal, a rectification and filter circuit, an electronic switch set, an energy storage module, a voltage measurement unit, a control unit and a power output terminal.

The power input terminal is adapted to connect with a dynamo. The power output terminal is adapted to connect with a load. The rectification and filter circuit has an output terminal and an input terminal connected to the power input terminal. The electronic switch set is connected between the output terminal of the rectification and filter circuit and a power output terminal. The energy storage module is respectively connected with the rectification and filter circuit and the power output terminal through the electronic switch set and has multiple energy storage units. The voltage measurement unit has a plurality of input terminals and an output terminal. The plurality of input terminals are respectively connected to the output terminal of the rectification and filter circuit and the power output terminal. The control unit has a built-in charge and discharge parameter table and is connected to the output terminal of the voltage measurement unit and is coupled to the energy storage module to switch the electronic switch set for charging and discharging.

When the dynamo powers on, the control unit measures the power generated by the dynamo and determines which energy storage unit is charged or discharged based on the built-in charge and discharge parameters. When detecting a power-consuming request, the control unit switches selects an energy storage unit according to the built-in charge and discharge parameters to supply power requested the load.

### BRIEF DESCRIPTION OF THE DRAWINGS

FIG. 1 is a circuit block diagram of a first preferred embodiment in accordance with the present invention;

FIG. 2 is a partial circuit diagram of a second preferred embodiment in accordance with the present invention; and

FIG. 3 is a circuit diagram of an analog switch in a first electronic switch and a second electronic switch of the electronic switch set in accordance with the present invention.

### DETAILED DESCRIPTION OF THE INVENTION

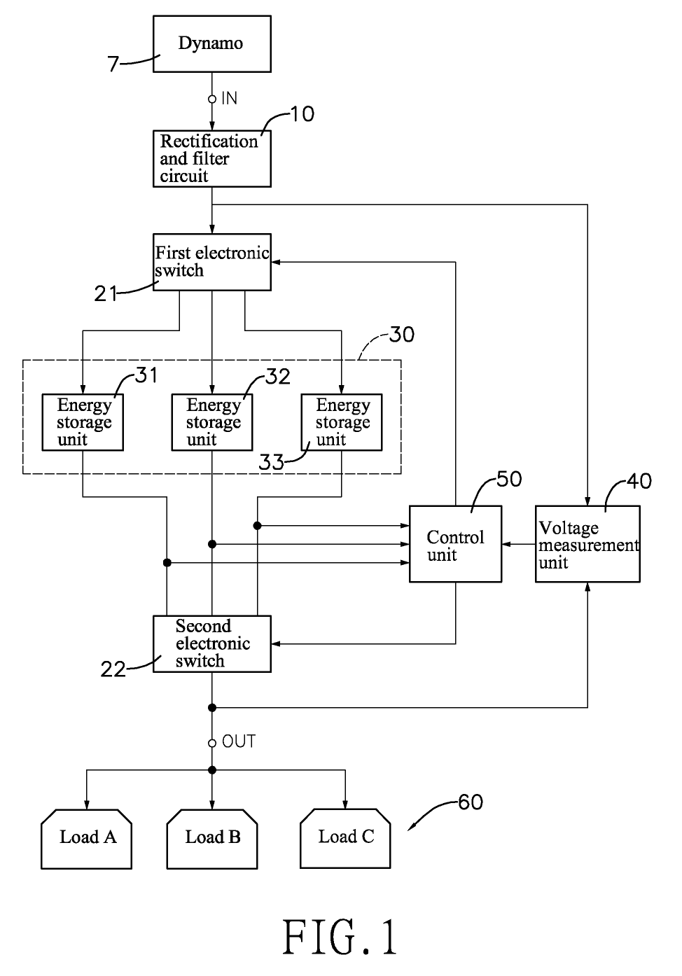

With reference to FIG. 1, a dynamo and power supply management device for bicycles has a power input terminal (IN), rectification and filter circuit 10, an electronic switch set, an energy storage module 30, a voltage measurement unit 40, a control unit 50 and a power output terminal (OUT).

The rectification and filter circuit 10 has an input terminal and an output terminal. The input terminal is connected to the power input terminal (IN) to which a dynamo 7 mounted on a bicycle is connected. Therefore, the dynamo 7 supplies power to the rectification and filter circuit 10 through the power input terminal (IN).

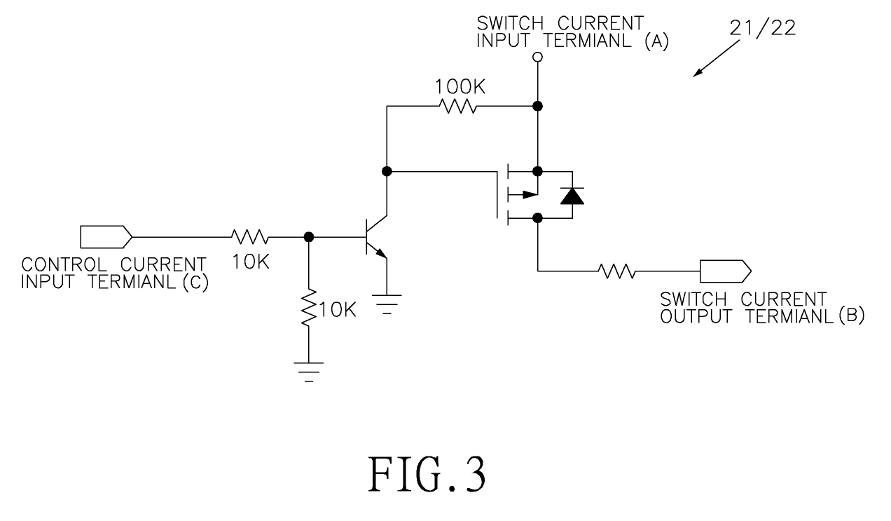

In the present embodiment, the electronic switch set has a first electronic switch 21 and a second electronic switch 22 respectively connected between the output terminal of the rectification and filter circuit 10 and the power output terminal (OUT). The first and second electronic switches 21, 22 are normally open and are controlled by the control unit 50 to switch on or off With reference to FIG. 3, a detailed circuit diagram associated with each of the first and second electronic switches 21, 22 is shown. When a voltage of the control current input end is high, the switch between the switch current input terminal and the switch current output terminal is turned on and a current flows from the switch current input terminal to the switch current output terminal. When the voltage of the control current input terminal is low, the switch between the switch current input terminal and the switch current output terminal is cut off and no current flows from the switch current input terminal to the switch current output terminal.

The energy storage module 30 has multiple energy storage units 31˜33. The energy storage units 31˜33 may be one of a secondary battery, a capacitor and an ultra capacitor or a battery array, a capacitor array and an ultra capacitor array. One of the energy storage units 31˜33 in the energy storage module 30 is selected by the control unit 50 through the first electronic switch 21 to perform charging. One of the energy storage units 31˜33 in the energy storage module 30 is selected by the control unit 50 through the second electronic switch 22 to perform discharging. Since loads 60 are connected to the power output terminal, the dynamo and power supply management device supplies the power from the energy storage module 30 to the loads 60.

Input terminals of the voltage measurement unit 40 are respectively connected to an output terminal of the rectification and filter circuit 10 and the power output terminal (OUT) to measure an input voltage from the rectification and filter circuit 10 and an output voltage from the power output terminal (OUT), and generate corresponding measured voltage signals. The control unit 50 is connected with output terminals of the voltage measurement unit 40 to acquire the measured voltage signals from the voltage measurement unit 40. The control unit 50 is also connected with output terminals of the energy storage units 31˜33 to acquire the stored voltage values to the control unit 50. Accordingly, the control unit 50 can acquire input voltage of the dynamo 7 and output voltage of the power output terminal (OUT) through the rectification and filter circuit 40 and the voltages of the energy storage units 31˜33. The control unit 50 determines which one of the energy storage units 31˜33 is charged by the power generated by the dynamo 7. Depending on the power storage statuses of the energy storage units 31˜33, one of the energy storage units 31˜33 is selectively connected with the power output terminal (OUT) by controlling the second electronic switch 22 to supply power to the load 60.

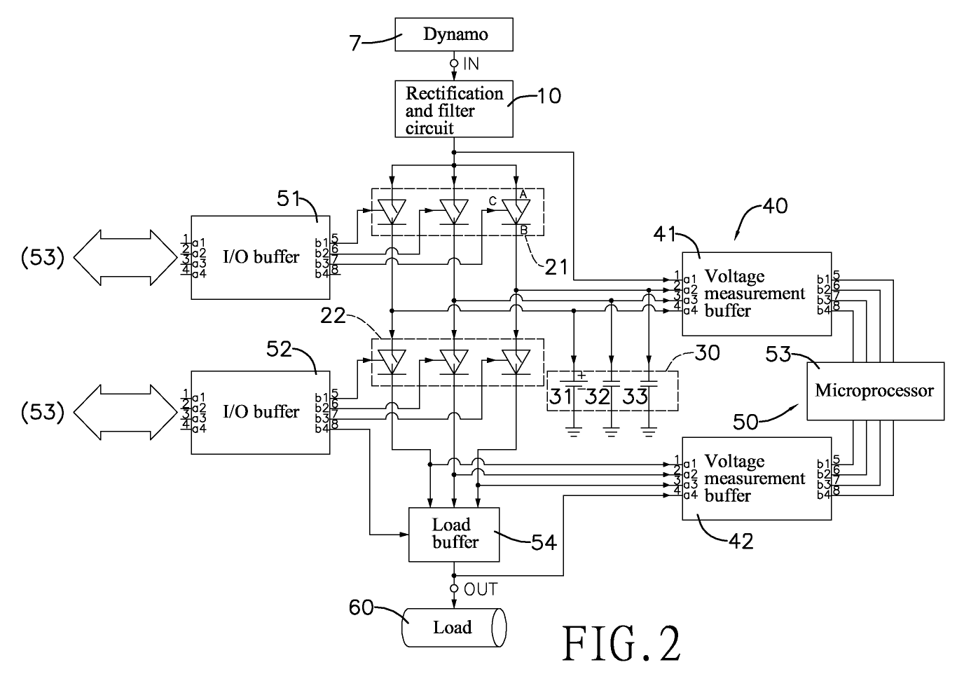

With reference to FIG. 2, a dynamo and power supply management device for bicycles has a power input terminal (IN), a rectification and filter circuit 10, an electronic switch set, an energy storage module 30, a voltage measurement unit 40, a control unit 50 and a power output terminal (OUT). The device has basically the same components as the first embodiment has but a more detailed description thereof is provided. The device differs from the first embodiment in the connection among the energy storage module 30, the voltage measurement unit 40 and the control unit 50. The voltage measurement unit 40 has two voltage measurement buffers 41, 42. Input terminals of one of the voltage measurement buffers 41, 42 are respectively connected with the output terminal of the rectification and filter circuit 10 and the output terminals of the first electronic switch 21. Input terminals of the other voltage measurement buffer 42 are respectively connected with the output terminals of the second electronic switch 22 and the output terminal of the load buffer 54. The control unit 50 includes a microprocessor 53 having a built-in charge and discharge parameter table. The charge and discharge parameter table records charge and discharge parameters of each energy storage units 31˜33. In the present embodiment, the microprocessor 53 has multiple input terminals connected with output terminals of the voltage measurement buffers 41, 42 and connected with multiple analog-to-digital converters (ADC) to convert measured voltage signals from the voltage measurement unit 40 into digital signals. Accordingly, the microprocessor 53 can acquire input voltage from the rectification and filter circuit 10 and output voltage from the power output terminal (OUT) and the voltages of the energy storage units 31˜33. The microprocessor 53 further has multiple I/O buffers 51, 52, which are respectively connected between the first electronic switch 21 and the microprocessor 53 and between the second electronic switch 22 and the microprocessor 53. The first and second electronic switches 21, 22 are composed of multiple normally open analog switches. With reference to FIG. 3, each of the analog switches highlighted in FIG. 2 by dash lines has a first transistor 23 and a second transistor 24. The first transistor 23 is a BJT transistor and the second transistor 24 is a MOSFET transistor. The base of the first transistor 23 is a control current input terminal (C), the collector thereof is connected to a gate of the second transistor 24 and is connected to the source of the second transistor 24 and a switch current input terminal (A) through a resistor (100K). The drain of the second transistor 24 is a switch current output terminal (B).

When the analog switch is used for the first electronic switch 21, the switch current input terminal (A) is connected to the rectification and filter circuit 10, the switch current output terminal (B) is connected to the voltage measurement buffer 41, and the control current input terminal (C) is connected to the I/O buffer 51. Accordingly, when the signal outputted by the I/O buffer 51 to the control current input terminal (C) is high, the second transistor 24 switches on so that current flows from the switch current input terminal (A) to the voltage measurement buffer 41 through the switch current output terminal (B). When the signal outputted by the I/O buffer 51 to the control current input terminal (C) is low, the first transistor 23 and the second transistor 24 all switch off and no current flows from the switch current input terminal (A) to the switch current output terminal (B).

When the analog switch is used for the first electronic switch 22, the switch current input terminal (A) is connected to the voltage measurement buffer 41, the switch current output terminal (B) is connected to the load buffer 54, and the control current input terminal (C) is connected to the I/O buffer 52. Accordingly, when the signal outputted by the I/O buffer 52 to the control current input terminal (C) is high, the second transistor 24 switches on so that current flows from the switch current input terminal (A) to the voltage measurement buffer 42 through the switch current output terminal (B). When the signal outputted by the I/O buffer 52 to the control current input terminal (C) is low, the first transistor 23 and the second transistor 24 all switch off and no current flows from the switch current input terminal (A) to the switch current output terminal (B).

The switch control terminals are connected with the output terminals of the microprocessor 53 through the I/O buffers 51, 52 and are controlled by the microprocessor 53. A load buffer 54 is mounted between the second electronic switch 22 and the power output terminal (OUT). The load buffer 54 is connected with the microprocessor 53 through the I/O buffer 52 and is controlled by the microprocessor 53. In collaboration with the comparison of those voltages with those in the built-in charge and discharge parameter table, the microprocessor 53 determines which one of the energy storage units 31˜33 is charged by the power generated by the dynamo 7. Depending on the power storage statuses of the energy storage units 31˜33, one of the energy storage units 31˜33 is selectively connected with the power output terminal (OUT) to supply power.

The foregoing description is associated with the substantial structure of the present invention. The operating concept is depicted in details as follows.

When the dynamo starts operating, the microprocessor 53 of the control unit 50 measures the power generated by the dynamo 7 and the power storage status of the energy storage units 31˜33 through the voltage measurement buffers 41, 42 respectively. The microprocessor 53 in collaboration with the built-in charge and discharge parameter table switches one of the analog switches of the first electronic switch 21 on and determines to charge the corresponding energy storage unit. When detecting a power-consuming demand, the microprocessor 53 switches on one of the analog switches of the second electronic switch 22 in accordance with the power storage status of the energy storage units 31˜33, the charge and discharge parameters and load condition to select a proper energy storage unit 31˜33 for supplying power to the load 60. By means of the aforementioned circuits, the dynamo from a bicycle satisfies the power-consuming demand of different load and enhance its operation efficiency.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A dynamo and power supply management device for bicycles, comprising:
a power input terminal adapted to connect with a dynamo;
a power output terminal adapted to connect with a load;
a rectification and filter circuit having an output terminal and an input terminal connected with to the power input terminal;
an electronic switch set connected between the output terminal of the rectification and filter circuit and a power output terminal;
an energy storage module connected with the rectification and filter circuit and the power output terminal through the electronic switch set and having multiple energy storage units;
a voltage measurement unit having a plurality of input terminals and an output terminal, the plurality of input terminals respectively connected to the output terminal of the rectification and filter circuit and the power output terminal; and
a control unit having a built-in charge and discharge parameter table and connected to the output terminal of the voltage measurement unit and coupled to the energy storage module to switch the electronic switch set for charging and discharging.

2. The dynamo and power supply management device for bicycles as claimed in claim 1, wherein the control unit is directly connected to the energy storage module.

3. The dynamo and power supply management device for bicycles as claimed in claim 1, wherein the control unit is connected to the energy storage module through the voltage measurement unit.

4. The dynamo and power supply management device for bicycles as claimed in claim 3, wherein
the electronic switch set comprises a first electronic switch and a second electronic switch respectively connected with the output terminal of the rectification and filter circuit and the power output terminal; and
the control unit comprises a microprocessor having multiple analog-to-digital converters;
an output terminal; and
multiple I/O buffers respectively connected between the first electronic switch and the microprocessor and the second electronic switch and the microprocessor.

5. The dynamo and power supply management device for bicycles as claimed in claim 4, wherein the first electronic switch and the second electronic switch have multiple normally open analog switches and a switch control terminal of each of the analog switches is connected to the output terminal of the microprocessor through the corresponding I/O buffer.

6. The dynamo and power supply management device for bicycles as claimed in claim 5, further comprising a load buffer mounted between the second electronic switch and the power output terminal, connected with the microprocessor through the I/O buffer connected between the microprocessor and the second electronic switch and controlled by the microprocessor.

7. The dynamo and power supply management device for bicycles as claimed in claim 6, wherein the voltage measurement unit comprises
a first voltage measurement buffer having input terminals respectively connected with the output terminal of the rectification and filter circuit and output terminals of the first electronic switch; and
a second voltage measurement buffer having input terminals respectively connected with output terminals of the second electronic switch and output terminals of the load buffer.

8. The dynamo and power supply management device for bicycles as claimed in claim 7, wherein the energy storage unit is one of a secondary battery, a capacitor and an ultra capacitor.

9. The dynamo and power supply management device for bicycles as claimed in claim 7, wherein each analog switch of the first electronic switch has a first transistor and a second transistor, the first transistor is a BJT and the second transistor is a MOSFET, a base of the first transistor is a control current input terminal connected to the corresponding I/O buffer, a collector of the first transistor is connected to a gate of the second transistor and is connected to a source of the second transistor and an output terminal of the rectification and filter circuit through a resistor, a drain of the second transistor is connected to a first voltage measurement buffer.

10. The dynamo and power supply management device for bicycles as claimed in claim 8, wherein each analog switch of the first electronic switch has a first transistor and a second transistor, the first transistor is a BJT and the second transistor is a MOSFET, a base of the first transistor is a control current input terminal connected to the corresponding I/O buffer, a collector of the first transistor is connected to a gate of the second transistor and is connected to a source of the second transistor and an output terminal of the rectification and filter circuit through a resistor, a drain of the second transistor is connected to a first voltage measurement buffer.

11. The dynamo and power supply management device for bicycles as claimed in claim 7, wherein each analog switch of the second electronic switch has a first transistor and a second transistor, the first transistor is a BJT and the second transistor is a MOSFET, a base of the first transistor is a control current input terminal connected to the corresponding I/O buffer, a collector of the first transistor is connected to a gate of the second transistor and is connected to a source of the second transistor and a first voltage measurement buffer through a resistor, a drain of the second transistor is connected to the load buffer.

12. The dynamo and power supply management device for bicycles as claimed in claim 8, wherein each analog switch of the second electronic switch has a first transistor and a second transistor, the first transistor is a BJT and the second transistor is a MOSFET, a base of the first transistor is a control current input terminal connected to the corresponding I/O buffer, a collector of the first transistor is connected to a gate of the second transistor and is connected to a source of the second transistor and a first voltage measurement buffer through a resistor, a drain of the second transistor is connected to the load buffer.
